(19) United States
(12) Patent Application Publication
(10) Pub. No.: US 2008/0079657 A1
(43) Pub. Date: Apr. 3, 2008

(54) MULTI-DISPLAY APPARATUS AND METHOD THEREOF

(75) Inventors: In-seo KEE, Yongin-si (KR); Young-gu LEE, Yongin-si (KR); Hong-shik SHIM, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/765,628

(22) Filed: Jun. 20, 2007

(30) Foreign Application Priority Data
Sep. 29, 2006 (KR) 10-2006-0096126

(51) Int. Cl. G09G 5/00

(52) U.S. Cl. 345/1.3

(57) ABSTRACT

A multi-display apparatus, which can greatly improve the image disconnection at a seam between unit panels when an image is viewed at an inclination angle, includes a plurality of unit panels, each including a display device between a substrate glass and a cover glass, wherein the plurality of unit panels are connected to each other with a step difference so that the display devices form a continuous display area at a seam, and a sum of thicknesses of the substrate glass and the cover glass for each unit panel is about 0.5 mm or less. A method of minimizing an image disconnection at a seam of a multi-display apparatus is also provided.

This application claims priority to Korean Patent Application No. 10-2006-0096126, filed on Sep. 29, 2006, and all the benefits accruing therefrom under 35 U.S.C. §119, and the contents of which in its entirety are herein incorporated by reference.

### BACKGROUND OF THE INVENTION

1. Field of the Invention

The present invention relates to a multi-display apparatus and a method thereof that displays an image by connecting a plurality of panels, and more particularly, to a multi-display apparatus and a method thereof that can minimize the image disconnection at a seam of the multi-display apparatus.

2. Description of the Related Art

Conventionally, multi-display apparatuses realize a large screen by connecting a plurality of display panels. In the past, a large screen was realized by connecting a plurality of Braun tubes, also known as cathode ray tubes (“CRTs”), into a large TV. However, recently, due to the increasing demand for a large screen in small mobile apparatuses such as mobile phones or personal digital assistants (“PDAs”), apparatuses that realize the large screen by connecting flat panel displays such as liquid crystal displays (“LCDs”), field emission displays (“FEDs”), plasma display panels (“PDPs”), and organic light-emitting diodes (“LEDs”) are being produced.

Conventionally, multi-display apparatuses are manufactured by connecting a plurality of unit panels 10 in parallel, as depicted in FIG. 1. However, an image at a seam between a pair of unit panels 10 is not smoothly formed at the seam when the unit panels 10 are connected to each other in parallel, as the unit panels 10 become frequently disconnected at the seam. Also, as schematically depicted in FIG. 1, a flat panel display has a sealing structure in which a display device 12 that includes a pixel is mounted on a substrate glass 11 and a cover glass 13 covering the display device 12 is attached to the substrate glass 11. As such, the cover glass 13 basically has a rim thickness t and the display device 12 is located on an inner portion of the cover glass 13. Therefore, as much as a disconnection distance w at the seam between a pair of display devices 12 occurs. The distance w between the pair of display devices 12 cannot be readily reduced since the distance w is inevitably required for the cover glass 13 to safely protect the display device 12 by covering the display device 12. Therefore, there is a limitation in improving the image disconnection at the seam between the unit panels 10 in the above parallel connection structure.

To solve the limitation, as depicted in FIG. 2, a structure has been proposed in which a pair of first and second unit panels 21 and 22 are disposed with a step difference and pixel boundaries of display devices 21b and 22b in the pair of first and second unit panels 21 and 22 are vertically aligned along line L. That is, after the pair of first and second unit panels 21 and 22 are disposed with the step difference as depicted in FIG. 2, a right side boundary surface of a pixel within the display device 21b of the first unit panel 21 is vertically aligned with a left side boundary surface of a pixel within the display device 22b of the second unit panel 22 along the vertical line L. In such form, the image disconnection at a seam between the pair of first and second unit panels 21 and 22 is minimized when an image that is to be displayed on the pair of first and second unit panels 21 and 22 is viewed from above from location (a). The multi-display apparatus of FIG. 2 also includes a transparent plate 23 mounted on the second unit panel 22 corresponding to the width of the first unit panel 21.

In comparison to the apparatus shown in FIG. 1, the multi-display apparatus having the above structure shown in FIG. 2 reduces the image disconnection at the seam when the image is viewed from above (a). However, when the image is viewed from the side at an inclination angle of approximately 30 degrees (b), the image disconnection at the seam between the pair of first and second unit panels 21 and 22 is clearly seen.

FIG. 3 illustrates a photograph of an image of a step difference in the multi-display apparatus of FIG. 2 viewed from the side at an inclination angle of approximately 30 degrees after display devices 21b and 22b of the pair of first and second unit panels 21 and 22 are allowed to emit light in a predetermined pattern. As shown in the photograph of FIG. 3, an image disconnection line S is clearly viewed near the seam between the pair of first and second unit panels 21 and 22 when the image is viewed from the side at an inclination angle. That is, the pair of first and second unit panels 21 and 22 have a step difference, and the step difference is not clearly noticed when the image is viewed from above (a), but when the image is viewed at an inclination angle, a separation distance between the divided image is noticed as much as the step difference. The thickness of substrate glasses 21a and 22a and cover glasses 21c and 22c of each of the first and second unit panels 21 and 22 respectively is 0.7 mm or more. The first and second unit panels 21 and 22 are conventionally used to realize a multi-image and the first and second unit panels 21 and 22 are manufactured using the substrate glasses 21a and 22a and the cover glasses 21c and 22c having a thickness of 0.7 mm or more, respectively. Therefore, if the pair of first and second unit panels 21 and 22 is disposed with the step difference, the height difference between the display devices 21b and 22b is at least 1.4 mm or more. This height difference of at least 1.4 mm or more can be a large hindrance in realizing a smoothly connected multi-image when viewed at an inclination angle. Furthermore, a gap between the pair of first and second unit panels 21 and 22 widens since an air gap G of approximately 50 μm is present as depicted in FIG. 4 due to a mechanical tolerance between the pair of first and second unit panels 21 and 22, and thus the step difference of the pair of first and second further increases.

### BRIEF SUMMARY OF THE INVENTION

The present invention provides a multi-display apparatus and a method thereof that can realize a smooth image at a seam of the multi-display apparatus when the image is viewed at an inclination angle.

According to exemplary embodiments of the present invention, a multi-display apparatus includes a plurality of unit panels, each unit panel including a display device between a substrate glass and a cover glass, and the plurality of unit panels are connected to each other with a step difference in a first arrangement of the unit panels so that the display devices form a continuous display area at a seam, wherein a sum of thicknesses of the substrate glass and the cover glass for each unit panel is about 0.5 mm or less.

The substrate glass and the cover glass for each unit panel respectively may have a thickness of about 0.2 mm or less.

The height difference between adjacent display devices of the plurality of unit panels may be about 0.5 mm or less.

The plurality of unit panels may be combined in a fold-type of combination in a second arrangement of the unit panels.

At least one row of pixels of each of the display devices may overlap at least one row of pixels of adjacent display devices at a seam where the plurality of unit panels are connected with a step difference.

According to other exemplary embodiments of the present invention, a multi-display apparatus includes a first unit panel including a first display device, a first substrate, and a first cover, the first display device enclosed between the first substrate and the first cover, and a second unit panel including a second display device, a second substrate, and a second cover, the second display device enclosed between the second substrate and the second cover, wherein the first unit panel partially overlaps the second unit panel, and a height difference between the first display device and the second display device is about 0.5 mm or less.

The height difference may be substantially equal to a sum of a thickness of the second substrate, a thickness of a portion of the first cover extending substantially parallel to the second substrate, and a distance between the portion of the first cover and the first display device.

Each of the first unit panel and the second unit panel may have a thickness of about 0.5 mm or less.

A transparent plate may be disposed on the second unit panel and may have a substantially same thickness as a thickness of the first unit panel.

The first substrate, second substrate, first cover, and second cover may each include glass and may be about 0.2 mm or less.

An edge of the first display device and an edge of the second display device may align along a plane perpendicularly intersecting an overlapping section of the first and second unit panels. Alternatively, at least one row of pixels of the first display device may overlap at least one row of pixels of the second display device in an overlapping section of the first and second unit panels.

The first unit panel may be pivotal with respect to the second unit panel along a hinge line.

According to other exemplary embodiments of the present invention, a method of minimizing an image disconnection at a seam of a multi-display apparatus, includes providing a first unit panel with a first display device, a first substrate, and a first cover, and enclosing the first display device between the first substrate and the first cover, providing a second unit panel with a second display device, a second substrate, and a second cover, and enclosing the second display device between the second substrate and the second cover, partially overlapping the second unit panel with the first unit panel, and limiting a height difference between the first display device and the second display device to about 0.5 mm or less.

Providing a first unit panel and providing a second unit panel may include limiting a thickness of each of the first unit panel and the second unit panel to about 0.5 mm or less, providing the first substrate, second substrate, first cover, and second cover formed of glass, and limiting a thickness of each of the first substrate, second substrate, first cover, and second cover to about 0.2 mm or less.

Partially overlapping the second unit panel with the first unit panel may include aligning an edge of the first display device and an edge of the second display device along a plane perpendicularly intersecting an overlapping section of the first and second unit panels. Alternatively, partially overlapping the second unit panel with the first unit panel may include overlapping at least one row of pixels of the first display device with at least one row of pixels of the second display device in an overlapping section of the first and second unit panels.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view illustrating a conventional multi-display apparatus of the prior art;

FIG. 2 is a cross-sectional view illustrating another conventional multi-display apparatus of the prior art;

FIG. 3 is a photograph of an image displayed on the multi-display apparatus of FIG. 2, which is viewed at an inclination angle;

FIG. 4 is an enlarged view of an air gap formed between unit panels in the conventional multi-display apparatus of FIG. 2;

FIG. 5 is a perspective view illustrating an exemplary multi-display apparatus according to an exemplary embodiment of the present invention;

FIG. 6 is a cross-sectional view illustrating a connection structure of exemplary unit panels in the exemplary multi-display apparatus of FIG. 5, according to an exemplary embodiment of the present invention;

FIG. 7 illustrates a photograph of an image displayed on the exemplary multi-display apparatus of FIG. 5, which is viewed at an inclination angle, according to an exemplary embodiment of the present invention; and

FIG. 8 is a cross-sectional view illustrating a modified version of the connection structure of exemplary unit panels of FIG. 6, according to an exemplary embodiment of the present invention.

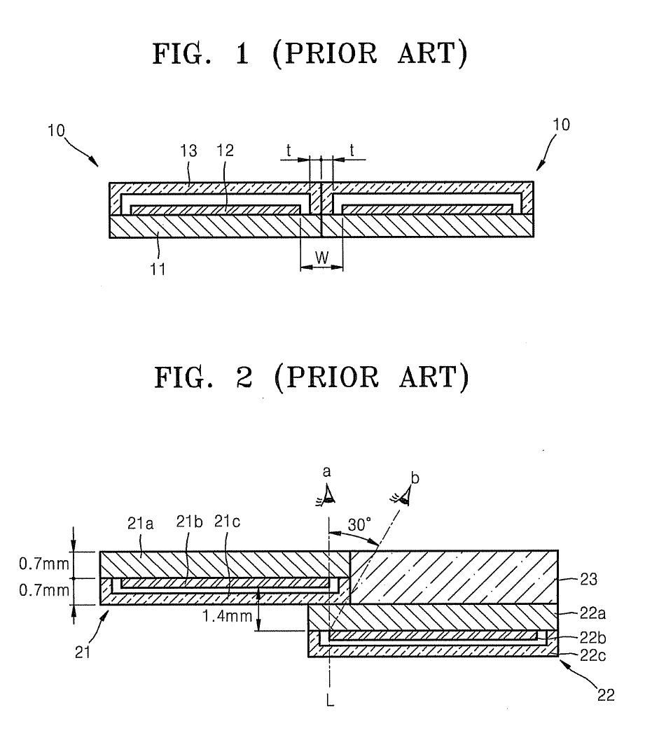

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

The present invention will now be described more fully with reference to the accompanying drawings in which exemplary embodiments of the invention are shown.

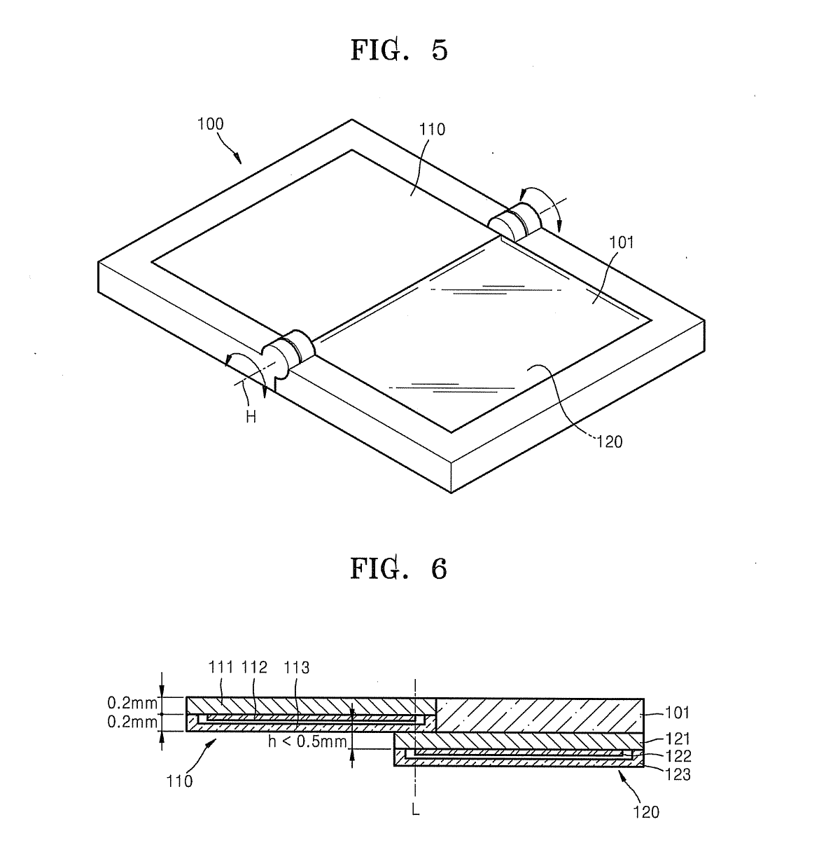

FIG. 5 is a perspective view illustrating a multi-display apparatus 100 according to an exemplary embodiment of the present invention. FIG. 6 is a cross-sectional view illustrating a connection structure of unit panels 110 and 120 in the multi-display apparatus 100 of FIG. 5, according to an exemplary embodiment of the present invention. Although a multi-display apparatus can be made by connecting more than two panels in various ways, in the present embodiment, for convenience of description, a case of connecting a pair of unit panels 110 and 120 will be described.

As depicted in FIG. 6, each of the unit panels 110 and 120 has a structure in which display devices 112 and 122 for displaying images are respectively stacked on substrates 111 and 121, and covers 113 and 123 that surround the display devices 112 and 122 are attached to the substrates 111 and 121. If the unit panels 110 and 120 are a top emission type, images formed by the display devices 112 and 122 are displayed through the covers 113 and 123, and if the unit panels 110 and 120 are a bottom emission type, the images are displayed through the substrates 111 and 121. In the present embodiment, a bottom emission type is described, and thus images are displayed through the substrates 111 and 121.

As depicted in FIG. 5, a pair of unit panels 110 and 120 form a multi-image by being connected in a folder type of connection in which the unit panels 110 and 120 can be folded and unfolded with respect to a hinge axis H. Thus, the unit panels 110 and 120 are movable between a first arrangement of the unit panels 110 and 120 and a second arrangement of the unit panels 110 and 120. In the folded configuration, the multi-display apparatus 100 is more easily transportable. In the unfolded configuration, the multi-display apparatus 100 forms a display screen capable of displaying a substantially continuous image across both unit panels 110 and 120. The pair of unit panels 110 and 120 is configured to have a step difference as depicted in FIG. 6 when the unit panels 110 and 120 are unfolded. That is, the unit panels 110 and 120 partially overlap each other by at least as much as is required to align boundaries of the display devices 112 and 122 along line L so that an image displayed on the multi-display apparatus 100 is seen as if the image is connected when a seam between the pair of unit panels 110 and 120 is viewed from above. In other words, separate images displayed on display devices 112 and 122 are viewable as a single continuous image. The multi-display apparatus 100 also includes a transparent plate 101 on the substrate 121 of the unit panel 120 to correspond to upper surfaces of the pair of the unit panels 110 and 120. The transparent plate 101 may have substantially the same thickness as the unit panel 110, such that a substantially planar surface is provided as a top surface of the multi-display apparatus 100, although the thickness of the unit panels 110 and 120 may also be the same. In a top emission type of display, the transparent plate 101 may be disposed on the cover 113 of the unit panel 110, and may have substantially the same thickness as the unit panel 120.

Furthermore, in the present embodiment, each unit panel 110 and 120 is formed to have an overall thickness of 0.5 mm or less by using the substrate glasses 111 and 121 and the cover glasses 113 and 123 respectively each having a thickness of about 0.2 mm or less. If the overall thickness of each unit panel 110 and 120 is about 0.5 mm or less, the image disconnection due to the step difference cannot be noticed even if the image is viewed at an inclination angle of approximately 30 degrees. That is, when boundaries of the display devices 112 and 122 are aligned along a line L by disposing the pair of unit panels 110 and 120 with the step difference, the image disconnection at the seam cannot be noticed if the image is viewed from above. The line L may lie within a plane perpendicularly intersecting the overlapping section of the unit panels 110 and 120. An image disconnection may be noticed when a height difference h between the display devices 112 and 122 is more than 0.5 mm. The height difference h, measured between the display device 112 and the display device 122, is substantially equal to a sum of a thickness of the substrate 121, a thickness of a portion of the cover 113 extending substantially parallel with the substrate 121, and a distance between the portion of the cover 113 and the display device 112. However, the height difference h between the pair of display devices 112 and 122 may be maintained within 0.5 mm so that the image disconnection at the seam due to the step difference cannot be noticed when the image is viewed at an inclination angle. Therefore, when the substrate glasses 111 and 121 and the cover glasses 113 and 123 respectively having a thickness of 0.2 mm or less are used, or at least a thickness of each of the plates disposed between the display devices 112 and 122 (such as the portion of the cover 113 parallel to the substrate 121 and the substrate 121) is about 0.2 mm or less, the height difference h between the pair of display devices 112 and 122 does not exceed 0.5 mm even if an air gap of 50 μm is present between the pair of unit panels 110 and 120. Alternatively, the height difference h between the pair of display devices 112 and 122 may still be maintained at 0.5 mm or less even if one of the cover 113 and the substrate 121 has a thickness greater than 0.2 mm, as long as the other of the cover 113 and the substrate 121 has a thickness adequately less than 0.2 mm. For example, the cover 113 may have a thickness of about 0.1 mm and the substrate 121 may have a thickness of about 0.3 mm, and the height difference between the pair of display devices 112 and 122 may still be no greater than 0.5 mm. In such form, the image disconnection at the seam cannot be noticed when the image is viewed from the side at an inclination angle.

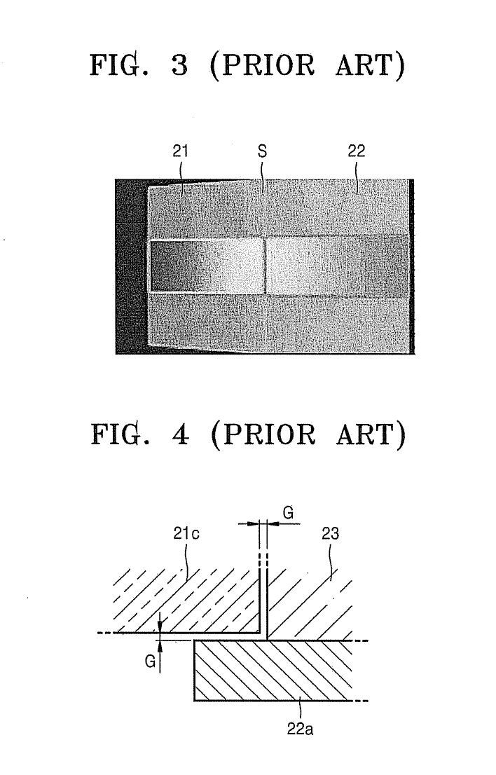

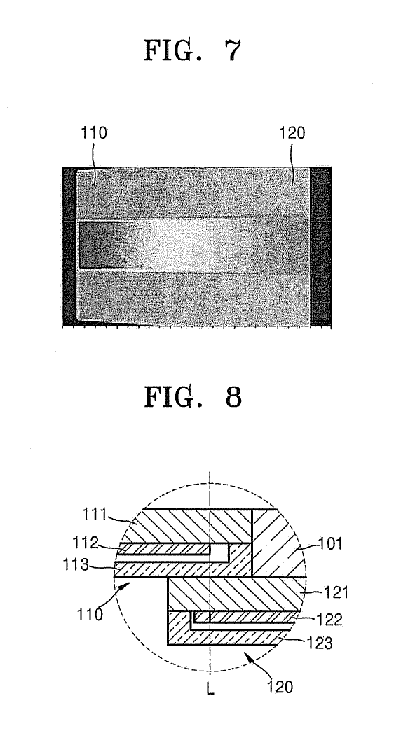

FIG. 7 illustrates a photograph of an image displayed on the multi-display apparatus 100 of FIG. 5, which is viewed at an inclination angle in the same manner as the photograph of FIG. 3, according to an exemplary embodiment of the present invention.

When the photograph of FIG. 7 is compared to the photograph of FIG. 3, the image disconnection line S caused by the step difference is clearly seen in FIG. 3 when the image is seen at an inclination angle of approximately 30 degrees. However, since thin glasses are used in the present embodiment, the image disconnection at the seam as illustrated in FIG. 7 is nearly unnoticed in the multi-display apparatus 100 of the exemplary embodiment even when the image is viewed at an inclination angle. Accordingly, a smooth multi-image can be seen at wide viewing angles.

FIG. 8 is a cross-sectional view illustrating a modified version of the connection structure of the exemplary unit panels of FIG. 6, according to an exemplary embodiment of the present invention.

In the exemplary embodiment shown in FIG. 6, the display devices 112 and 122 of the pair of unit panels 110 and 120 are aligned along line L so as to not to be overlapped. However, the display devices 112 and 122 can overlap by one or more pixel rows as depicted in FIG. 8. In such a case, the same image information must be applied to the overlapping portion of each of the display devices 112 and 122, and thus, the image disconnection between two images can further be improved.

Also, when the thickness of the glasses for forming the substrate glasses 111 and 121 and the cover glasses 113 and 123 are reduced, the overall multi-display apparatus 100 is lightweight and slim. Therefore, even when the multi-display apparatus 100 is formed as a folding structure, operation of the multi-display apparatus 100 is convenient since a moving part of the multi-display apparatus 100 is lightweight and slim.

Meanwhile, the display devices 112 and 122 may include various flat panel display devices such as liquid crystal displays (“LCDs”), field emission displays (“FEDs”), plasma display panels (“PDPs”), and organic light-emitting diodes (“OLEDs”).

The use of the multi-display apparatus according to the present invention can secure image continuity by connecting a pair of unit panels with a step difference and can realize a high quality multi-image, in which a pair of images is smoothly connected when the image is viewed from the side at an inclination angle by minimizing the step difference of the pair of unit panels.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A multi-display apparatus comprising:
a plurality of unit panels, each unit panel including a display device between a substrate glass and a cover glass, and the plurality of unit panels are connected to each other with a step difference in a first arrangement of the unit panels so that the display devices form a continuous display area at a seam;
wherein a sum of thicknesses of the substrate glass and the cover glass for each unit panel is about 0.5 mm or less.

2. The multi-display apparatus of claim 1, wherein the substrate glass and the cover glass for each unit panel respectively have a thickness of about 0.2 mm or less.

3. The multi-display apparatus of claim 1, wherein a height difference between adjacent display devices of the plurality of unit panels is about 0.5 mm or less.

4. The multi-display apparatus of claim 1, wherein the plurality of unit panels are combined in a fold-type of combination in a second arrangement of the unit panels.

5. The multi-display apparatus of claim 1, wherein at least one row of pixels of each of the display devices overlap at least one row of pixels of adjacent display devices at a seam where the plurality of unit panels are connected with a step difference.

6. A multi-display apparatus comprising:
a first unit panel including a first display device, a first substrate, and a first cover, the first display device enclosed between the first substrate and the first cover; and,
a second unit panel including a second display device, a second substrate, and a second cover, the second display device enclosed between the second substrate and the second cover;
wherein the first unit panel partially overlaps the second unit panel, and a height difference between the first display device and the second display device is about 0.5 mm or less.

7. The multi-display apparatus of claim 6, wherein the height difference is substantially equal to a sum of a thickness of the second substrate, a thickness of a portion of the first cover extending substantially parallel to the second substrate, and a distance between the portion of the first cover and the first display device.

8. The multi-display apparatus of claim 6, wherein each of the first unit panel and the second unit panel has a thickness of about 0.5 mm or less.

9. The multi-display apparatus of claim 6, further comprising a transparent plate disposed on the second unit panel and having a substantially same thickness as a thickness of the first unit panel.

10. The multi-display apparatus of claim 6, wherein the first substrate, second substrate, first cover, and second cover each include glass.

11. The multi-display apparatus of claim 6, wherein a thickness of each of the first substrate, second substrate, first cover, and second cover is about 0.2 mm or less.

12. The multi-display apparatus of claim 6, wherein an edge of the first display device and an edge of the second display device align along a plane perpendicularly intersecting an overlapping section of the first and second unit panels.

13. The multi-display apparatus of claim 6, wherein at least one row of pixels of the first display device overlaps at least one row of pixels of the second display device in an overlapping section of the first and second unit panels.

14. The multi-display apparatus of claim 6, wherein the first unit panel is pivotal with respect to the second unit panel along a hinge line.

15. A method of minimizing an image disconnection at a seam of a multi-display apparatus, the method comprising:
providing a first unit panel with a first display device, a first substrate, and a first cover, and enclosing the first display device between the first substrate and the first cover;
providing a second unit panel with a second display device, a second substrate, and a second cover, and enclosing the second display device between the second substrate and the second cover;
partially overlapping the second unit panel with the first unit panel; and,
limiting a height difference between the first display device and the second display device to about 0.5 mm or less.

16. The method of claim 15, wherein providing a first unit panel and providing a second unit panel includes limiting a thickness of each of the first unit panel and the second unit panel to about 0.5 mm or less.

17. The method of claim 15, wherein providing a first unit panel and providing a second unit panel includes providing the first substrate, second substrate, first cover, and second cover formed of glass.

18. The method of claim 15, wherein providing a first unit panel and providing a second unit panel includes limiting a thickness of each of the first substrate, second substrate, first cover, and second cover to about 0.2 mm or less.

19. The method of claim 15, wherein partially overlapping the second unit panel with the first unit panel includes aligning an edge of the first display device and an edge of the second display device along a plane perpendicularly intersecting an overlapping section of the first and second unit panels.

20. The method of claim 15, wherein partially overlapping the second unit panel with the first unit panel includes overlapping at least one row of pixels of the first display device with at least one row of pixels of the second display device in an overlapping section of the first and second unit panels.
